(19) United States
(12) Patent Application Publication
(10) Pub. No.: US 2016/0009129 A1
(43) Pub. Date: Jan. 14, 2016

(54) HUB UNIT

(71) Applicant: JTEKT CORPORATION, Osaka (JP)

(72) Inventors: Yoshinori MASUDA, Yamatotakada-shi (JP); Youichi TSUZAKI, Kashiba-shi (JP)

(21) Appl. No.: 14/788,955

(22) Filed: Jul. 1, 2015

(30) Foreign Application Priority Data
Jul. 10, 2014 (JP) 2014-142157
Apr. 9, 2015 (JP) 2015-079867

(51) Int. Cl. B60B 27/00; B60B 27/02

(52) U.S. Cl. CPC B60B 27/0073; B60B 27/02; B60B 2900/511

(57) ABSTRACT

A hub unit includes an outer ring member and an inner ring member disposed inward of the outer ring member and coaxially with the outer ring member. The inner ring member is provided with a wheel attachment flange. The wheel attachment flange is provided with a plurality of bolt holes that are arranged along a circumferential direction and into which hub bolts for fixing a wheel are press-fitted. At least one of the hub bolts is provided with a cutout on a side portion of a head thereof. When a minimum value of a distance from an axis of the hub bolt to a cutout edge of the cutout is denoted as A and a radius of the bolt holes into which the hub bolts are press-fitted is denoted as B, A≧B is satisfied.

### INCORPORATION BY REFERENCE

The disclosure of Japanese Patent Applications Nos. 2014-142157 filed on Jul. 10, 2014 and 2015-079867 filed on Apr. 9, 2015 including the specification, drawings and abstract, are incorporated herein by reference in its entirety.

### BACKGROUND OF THE INVENTION

1. Field of the Invention

The present invention relates to a hub unit.

2. Description of Related Art

A hub unit is used to support wheels of a vehicle such as an automobile such that the wheels are rotatable relative to a suspension for a vehicle body. In conventional common hub units, an outer ring member forming the hub unit is fixed to the vehicle body via a knuckle. On an outer periphery of an inner ring member also forming the hub unit, a wheel attachment flange is formed to which a brake rotor or a wheel is coupled.

FIG. 7 is a partial sectional view of an example of a conventional hub unit. FIG. 8 is a diagram illustrating the hub unit H1 depicted in FIG. 7 as viewed from an inboard side. In FIG. 8, a wheel attachment flange 30 is depicted on an outboard side. An outer ring member 32 is depicted on the inboard side. On an outer periphery of the outer ring member 32, a flange 31 is formed via which the outer ring member 32 is attached to the vehicle body. In FIG. 8, the wheel and the like to be described later are not depicted to facilitate the understanding.

The hub unit H1 includes the outer ring member 32, an inner ring member 33, and seal members 34a and 34b. The outer ring member 32 is fixed to the vehicle body. The inner ring member 33 is disposed inward of the outer ring member 32 and coaxially with the outer ring member 32. The seal members 34a and 34b are disposed at the opposite ends of an annular space S between the outer ring member 32 and the inner ring member 33. The inner ring member 33 includes a hub shaft 35 and an inner ring forming member 36 fitted over an outer diameter of an inboard end of the hub shaft 35.

On an outer periphery of an outboard end of the hub shaft 35, the wheel attachment flange 30 is formed via which the wheel is attached to the hub unit H1. Bolt holes 37 are formed along a peripheral portion of the wheel attachment flange 30 at predetermined intervals. A wheel 39 and a brake rotor 40 that are wheel forming components are attached to hub bolts 38 press-fitted into the bolt holes 37.

When a vehicle travels on a rough road, the hub bolts 38 may be damaged or broken due to, for example, repeated transmission of an impact force via the wheel 39. In this case, it is desired, for a simplified replacement operation, to pull out only the damaged hub bolt 38 from the bolt hole 37 in the wheel attachment flange 30 with the hub unit H1 remaining installed in the vehicle body and then to insert a new hub bolt 38 into the bolt hole 37.

On the other hand, the outer diameter of the outer ring member 32 may be set to be large in order to enhance the rigidity of a bearing. In this case, a head 38a of the hub bolt 38 interferes with an outer edge 32a of the outer ring member 32 or an outer edge 31a of the flange 31 formed on the outer periphery of the outer ring member 32. As a result, the hub bolt 38 may be prevented from being pulled out from the bolt hole 37 when the hub unit H1 remains installed in the vehicle body.

In contrast, the outer diameter of the outer ring member 32 or the flange 31 may be reduced by machining. However, such machining needs much time and effort, increasing costs. Furthermore, the needed rigidity may fail to be ensured.

Thus, a cutout 41 is formed on a side portion of the head 38a of the hub bolt 38 as depicted in FIGS. 8 and 9. There has been a proposal that the cutout 41 be utilized to prevent the head 38a of the hub bolt 38 from interfering with the outer edge 32a of the outer ring member 32 or the outer edge 31a of the flange 31 when the hub bolt 38 is pulled out from the bolt hole 37 or when the hub bolt 38 is inserted into the bolt hole 37 (see Japanese Patent Application Publication No. 2002-347402 (JP 2002-347402 A) (Paragraphs [0032] to [0037] and FIGS. 4 to 7)). That is, the cutout 41 is formed such that the head 38a of the hub bolt 38 is sized so as not to interfere with the outer edge 32a of the outer ring member 32 or the outer edge 31a of the flange 31 when an attempt is made to insert the hub bolt 38 into the bolt hole 37 with the cutout 41 facing the outer edge 32a of the outer ring member 32 or the outer edge 31a of the flange 31. The flange 31 is formed around the outer periphery of the outer ring member 32. The outer edge 31a refers to the radially outer edge of the flange 31 as depicted in FIG. 8. The outer edge 32a is the radially outer edge of the outer ring member 32 excluding the outer edge 31a of the flange 31.

When the head 38a is shaped like the letter D as viewed in plan by forming the cutout 41 on the head 38a, possible interference between the hub bolt 38 and the outer ring member 32 or the flange 31 can be avoided during a replacement operation.

However, with the hub bolt 38 press-fitted into the bolt hole 37, part of the bolt hole 37 may be exposed. When the bolt hole 37 has an exposed portion 42 (see FIG. 9), rain water or salt water may enter the hub unit through the exposed portion 42. Then, the hub bolt 38 or a nut 43 (see FIG. 7) may be corroded.

### SUMMARY OF THE INVENTION

An object of the present invention is to provide a hub unit that allows prevention of external exposure of a bolt hole into which a hub bolt for fixing a wheel is press-fitted.

A hub unit according to an aspect of the present invention includes an outer ring member and an inner ring member disposed inward of the outer ring member and coaxially with the outer ring member. The inner ring member is provided with a wheel attachment flange. The wheel attachment flange is provided with a plurality of bolt holes that are arranged along a circumferential direction and into which hub bolts for fixing a wheel are press-fitted. At least one of the hub bolts is provided with a cutout on a side portion of a head thereof. In the hub unit, when a minimum value of a distance from an axis of the hub bolt to a cutout edge of the cutout is denoted as A and a radius of the bolt holes into which the hub bolts are press-fitted is denoted as B, A≧B is satisfied.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a partial sectional view illustrating an embodiment of a hub unit of the present invention;

FIG. 2 is a partial sectional view illustrating a wheel attachment flange of a hub shaft depicted in FIG. 1;

FIG. 3 is a side view illustrating an example of a hub bolt in the present invention;

FIG. 4 is a plan view illustrating the hub bolt depicted in FIG. 3;

FIG. 5 is a plan view illustrating a state where the hub bolt is press-fitted into a bolt hole in the wheel attachment flange;

FIG. 6 is a plan view illustrating another example of a cutout formed on a head of the hub bolt;

FIG. 7 is a partial sectional view illustrating an example of a conventional hub unit;

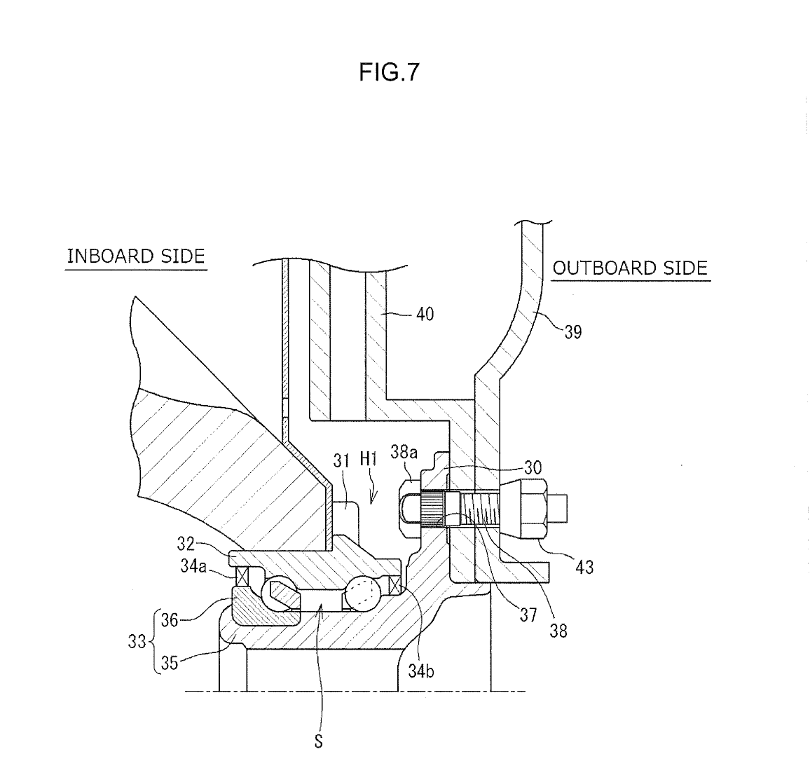

FIG. 8 is a diagram of the conventional hub unit as viewed from an inboard side; and

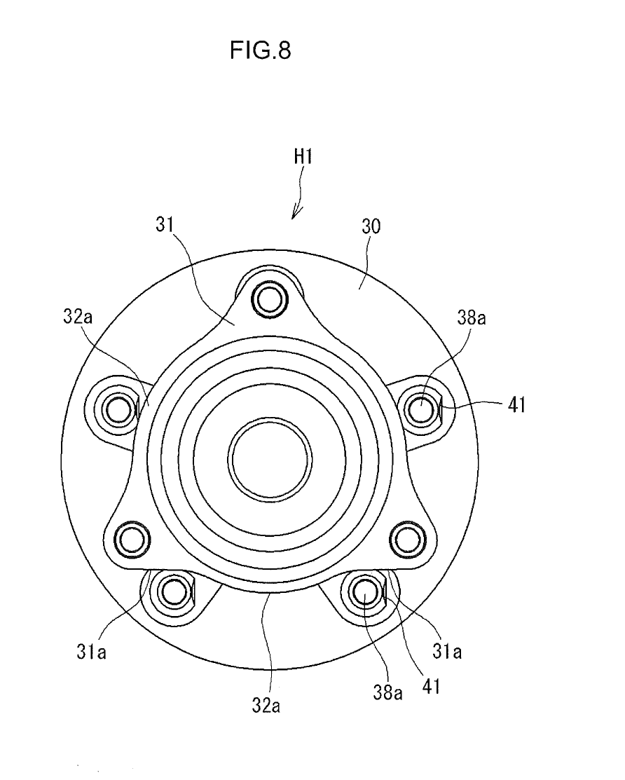

FIG. 9 is a plan view illustrating a periphery of a hub bolt in the conventional hub unit.

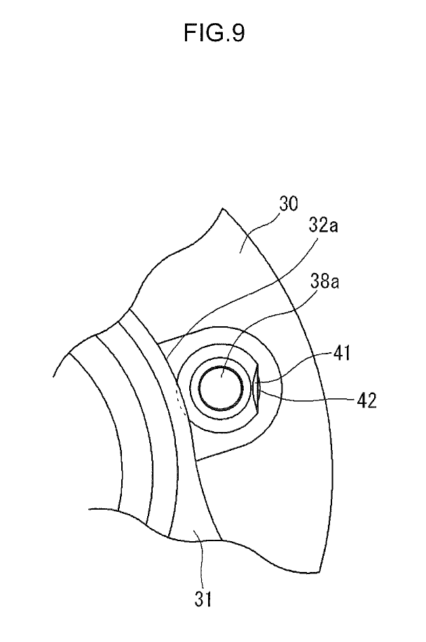

### DETAILED DESCRIPTION OF EMBODIMENTS

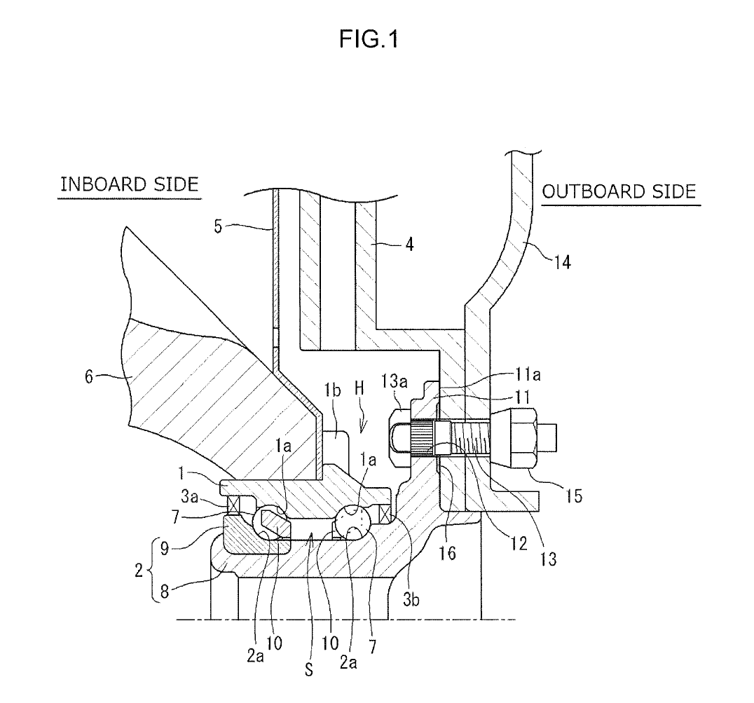

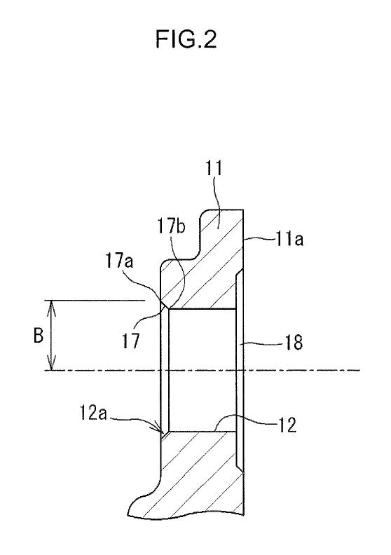

An embodiment of a hub unit of the present invention will be described below in detail with reference to the attached drawings. FIG. 1 is a partial sectional view illustrating a hub unit H according to an embodiment of the present invention. FIG. 2 is a partial sectional view illustrating a wheel attachment flange of a hub shaft depicted in FIG. 1. In FIGS. 1 and 2, the left side is an inboard side, and the right side is an outboard side.

The hub unit H according to the present embodiment is a hub unit for a driving wheel axle in a vehicle. The hub unit H includes an outer ring member 1, an inner ring member 2, and seal members 3a and 3b. The outer ring member 1 is fixed to a vehicle body. The inner ring member 2 is disposed inward of the outer ring member 1 and coaxially with the outer ring member 1. The seal members 3a and 3b are disposed at the opposite ends of an annular space S between the outer ring member 1 and the inner ring member 2. On an outer periphery of the outer ring member 1, a dust cover 5 shaped generally like a disc as viewed in an axial direction is disposed to prevent scattering stones from colliding against a siding surface of a brake rotor 4.

The outer ring member 1 is provided with a flange 1b via which the outer ring member 1 is fixed to a vehicle body. The flange 1b is fixed to the vehicle body via a knuckle 6. The outer ring member 1 is a double row outer ring member having two outer ring raceway surfaces 1a on an inner peripheral surface thereof. The inner ring member 2 has inner ring raceway surfaces 2a opposite to the outer ring raceway surfaces 1a. Balls 7 that are rolling elements are disposed between the outer ring raceway surfaces 1a and the inner ring raceway surfaces 2a.

The inner ring member 2 includes a hub shaft 8 and an inner ring forming member 9. The inner ring forming member 9 is a separate member fitted on the outer diameter of an inboard end of the hub shaft 8. The hub shaft 8 is supported by the outer ring member 1 via the plurality of balls 7 so as to be rotatable.

The balls 7 are held on the inner ring raceway surfaces 2a by a cage 10 at predetermined intervals in a circumferential direction. The opposite ends of the annular space S between the inner ring member 2 and the outer ring member 1 are sealed by the seal members 3a and 3b. The seal members 3a and 3b are disposed mainly to prevent external foreign matter (muddy water, fine dirt, or the like) from entering the bearing.

On an outer periphery of an outboard end of the hub shaft 8, a wheel attachment flange 11 is formed via which a wheel is attached to the hub unit H. Bolt holes 12 are formed at a peripheral edge of the wheel attachment flange 11 at predetermined intervals along a circumferential direction. A wheel 14 and a brake rotor 4 that are wheel forming components are attached to hub bolts 13 press-fitted into the bolt holes 12. The wheel 14 and the brake rotor 4 are fastened together using nuts 15.

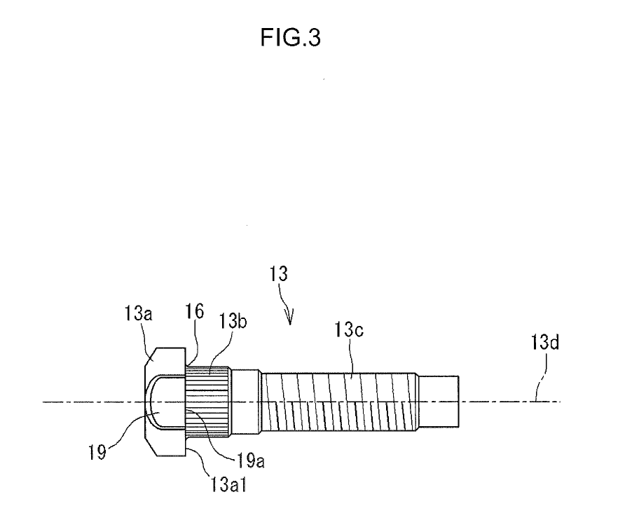

As depicted in FIG. 3, the hub bolt 13 has a head 13a, a serration portion 13b, and a threaded portion 13c. The serration portion 13b is press-fitted into the bolt hole 12 to fix the hub bolt 13 to the wheel attachment flange 11. The nut 15 is fastened to the threaded portion 13c. A rounded portion 16 is formed under the head of the hub bolt 13. A chamfered portion 17 (see FIG. 2) that allows the rounded portion 16 to be housed is formed on a peripheral edge of the bolt hole 12 on a side thereof from which the hub bolt 13 is inserted (inboard side, the left of FIGS. 1 and 2). The chamfered portion 17 has a large-diameter edge 17a and a small-diameter edge 17b. The diameter of the small-diameter edge 17b is the same as the inner diameter of a part of the bolt hole 12 into which the serration portion 13b is press-fitted. The “bolt hole” as used herein includes an annular space 12a resulting from formation of the chamfered portion 17.

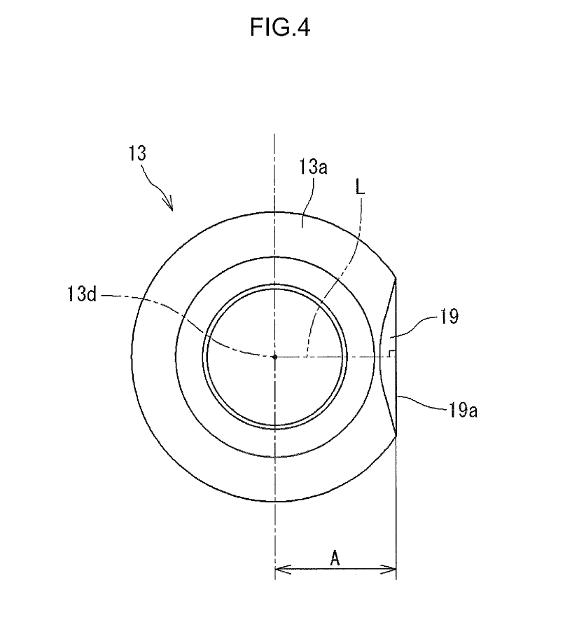

In some of the hub bolts 13, a cutout 19 is formed on a side portion of the head 13a as depicted in FIGS. 3 and 4. The cutout 19 is formed on the hub bolts 13, the heads 13a of which may interfere with an outer edge of the outer ring member 1 or a flange 1b when the hub bolt 13 is pulled out from the bolt hole 12. The cutout 19 can be formed, for example, by cutting.

In regard to the cutout 19, the present inventors have found that an excessively large cutout 19 may cause a part of the bolt hole 12 to be exposed when the hub bolt 13 is press-fitted into the bolt hole 12. The exposed bolt hole 12 may cause rain water or salt water to enter the hub unit through the exposed part, leading to corrosion of the hub bolt 13 or the nut 15, as described above.

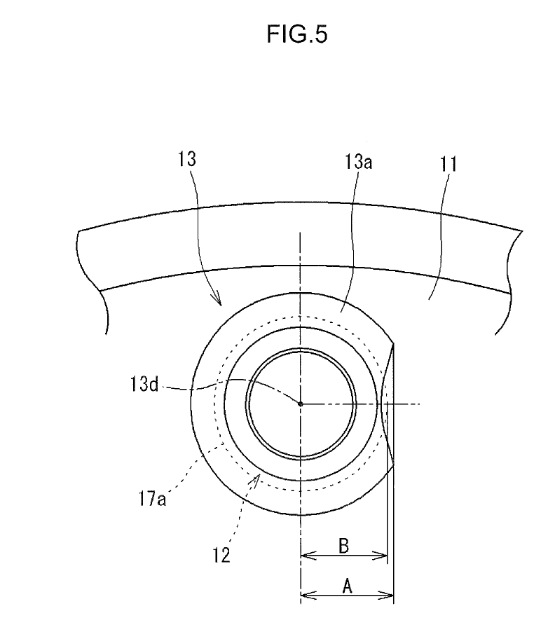

The distance from the axis 13d of the hub bolt 13 to a cutout edge 19a of the cutout 19 is denoted as A (see FIGS. 4 and 5). The radius of the bolt hole 12 on the side thereof from which the hub bolt 13 is press-fitted is denoted as B (see FIG. 2 and FIG. 5). In the present embodiment, the sizes of A and B are adjusted to satisfy A≧B. In the present embodiment, the cutout edge 19a appears linear when the head 13a of the hub bolt 13 is viewed from the front as depicted in FIGS. 4 and 5. Thus, the length of a perpendicular line L from the axis 13d of the hub bolt 13 to the cutout edge 19a is equal to the minimum value A of the above-described distance.

Specifically, the degree of chamfering of the chamfered portion 17 is reduced to decrease the radius B of the large-diameter edge 17a, that is, the radius of the bolt hole 12 on the side thereof from which the hub bolt 13 is press-fitted. Alternatively, the degree of cutting of the cutout 19 is reduced to increase the minimum value A of the above-described distance. In the present embodiment, one or both of these measures may be adopted to adjust the sizes of A and B such that A≧B. The cutout edge 19a as used herein refers to a boundary between the cutout 19 and a bearing surface 13a1 (see FIG. 3) of the head 13a of the hub bolt 13.

In the present embodiment, the cutout 19 is formed on the side portion of the head 13a of the hub bolt 13. Therefore, the head 13a of the hub bolt 13 can be prevented from interfering with the outer edge of the outer ring member 1 or the flange 1b when a damaged or broken hub bolt is pulled out from the bolt hole 12 in the wheel attachment flange 11 and when a new hub bolt is press-fitted into the bolt hole 12 in the wheel attachment flange 11. Moreover, the sizes of A and B are adjusted such that A≧B. Therefore, the bolt hole 12 can be prevented from being exposed to the exterior when the hub bolt 13 is inserted into the bolt hole 12. This allows prevention of a situation where rain water or salt water enters an area where the hub bolt 13 and the bolt hole 12 are fastened or fitted together, leading to corrosion of the hub bolt 13 or the nut 15.

In the present embodiment, an annular groove 18 is formed in a flange surface 11a, one of the flange surfaces of the wheel attachment flange 11 to which the brake rotor 4 is attached (the outboard flange surface located on the right of FIGS. 1 and 2). The annular groove 18 is formed in order to enhance the face runout accuracy of the flange surface 11a to which the brake rotor 4 is attached. Specifically, the flange surface 11a is formed so as to limit, to within the annular groove, local deformation of the bolt hole periphery or waviness of the flange surface resulting from press-fitting of the hub bolt 13 into the bolt hole 12. Thus, the annular groove 18 prevents a situation where the deformation or waviness affects the flange surface 11a outside the annular groove 18.

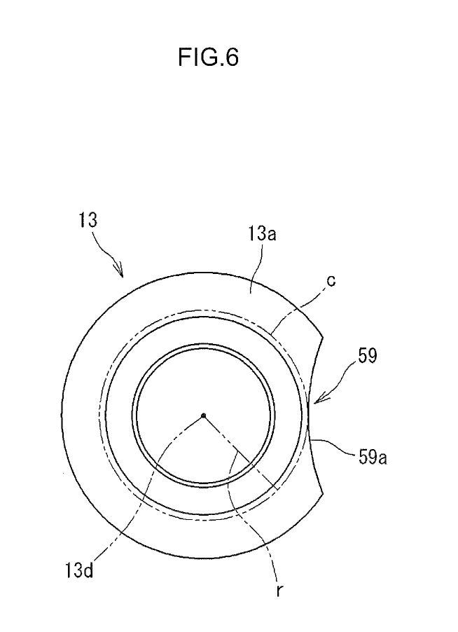

The present invention is not limited to the above-described embodiment, and various changes may be made to the embodiment within the scope of the claims. For example, in the above-described embodiment, the cutout 19 having the cutout edge 19a that appears linear when the head 13a of the hub bolt 13 is viewed from the front is formed on the side portion of the head 13a as depicted in FIGS. 4 and 5. However, a cutout with another shape may be adopted. For example, as depicted in FIG. 6, a cutout 59 having a cutout edge 59a that appears curved when the head 13a of the hub bolt 13 is viewed from the front may be formed on the side portion of the head 13a. In this case, among virtual circles around the axis 13d of the hub bolt 13, the radius r of a virtual circle c passing through a position on the cutout edge 59a closest to the axis 13d is the minimum value A of the distance from the axis 13d of the hub bolt 13 to the cutout edge 59a of the cutout 59.

The hub unit of the present invention allows prevention of external exposure of the bolt hole into which the hub bolt for fixing the wheel is press-fitted.

What is claimed is:

1. A hub unit comprising:
an outer ring member; and
an inner ring member disposed inward of the outer ring member and coaxially with the outer ring member,
the inner ring member being provided with a wheel attachment flange,
the wheel attachment flange being provided with a plurality of bolt holes that are arranged along a circumferential direction and into which hub bolts for fixing a wheel are press-fitted, and
at least one of the hub bolts being provided with a cutout on a side portion of a head thereof, wherein
when a minimum value of a distance from an axis of the hub bolt to a cutout edge of the cutout is denoted as A and a radius of the bolt holes into which the hub bolts are press-fitted is denoted as B, A≧B is satisfied.
